(19) United States
(12) Patent Application Publication
(10) Pub. No.: US 2023/0410388 A1
(43) Pub. Date: Dec. 21, 2023

(54) LABELING DEVICE, LABELING METHOD, LABELING PROGRAM, AND RECORDING MEDIUM

(71) Applicant: NEC Corporation, Minato-ku, Tokyo (JP)

(72) Inventors: Kei KAWANOBE, Tokyo (JP); Daisuke Sugii, Tokyo (JP); Toru Yada, Tokyo (JP); Yohei Iizawa, Tokyo (JP)

(73) Assignee: NEC Corporation, Minato-ku, Tokyo (JP)

(21) Appl. No.: 18/036,838

(22) PCT Filed: Nov. 20, 2020
(86) PCT No.: PCT/JP2020/043329

§ 371 Date: May 12, 2023

(51) Int. Cl. G06T 11/00; G06V 20/70

(52) U.S. Cl. CPC G06T 11/001; G06V 20/70; G06V 2201/07

(57) ABSTRACT

In order to enable a user to efficiently label a region of a target object in an image, a labeling device (100) includes: a display processing section (11) which causes a first target image and a color palette to be displayed; and a marking processing section (13) which marks a region on the first target image and a region on the color palette in response to an input from the user. In response to the input from the user with respect to one of the region on the first target image and the region on the color palette, the marking processing section (13) marks the other.

### TECHNICAL FIELD

The present invention relates to a labeling device, a labeling method, a labeling program, and a recording medium, each of which is for labeling a region in an image.

### BACKGROUND ART

In recent years, techniques for recognizing a target object in an image with use of artificial intelligence (AI) have been developed. Such AI can be realized, for example, by training AI with use of training data which is obtained by labeling (annotating) a region of a target object in an image on a pixel-by-pixel basis. However, a labeling operation for creating such training data is complicated.

As a technique for labeling an image on a pixel-by-pixel basis, Patent Document 1, for example, discloses a technique in which, in a case where a pixel which shows the same color and which is labeled is present in the vicinity of a pixel to be labeled, a process of putting, to the pixel, the same label as that of the pixel in the vicinity is carried out. Patent Document 2 discloses a Watershed algorithm which determines a boundary in an image with use of a gradient of brightness of the image.

### CITATION LIST

### Patent Literature

[Patent Literature 1]
Japanese Patent Application Publication Tokukai No. 2010-124346
[Patent Literature 2]
Japanese Patent Application Publication Tokukai No. 2013-250621

### SUMMARY OF INVENTION

### Technical Problem

However, in a case where a target object greatly varies in color shade, color lightness, range, and the like, it is difficult to reduce the complicacy of a labeling operation by the technique of Patent Document 1. In a case where labeling is carried out with use of an image processing algorithm such as the Watershed algorithm disclosed in Patent Document 2, it may be impossible to carry out intended labeling.

An example aspect of the present invention has been made in view of the above problem, and an example object thereof is to provide a labeling device, a labeling method, a labeling program, and a recording medium in which the labeling program is stored, each of which makes it possible for a user to efficiently label a region of a target object in an image.

### Solution to Problem

A labeling device according to an example aspect of the present invention includes: a display processing section which causes a first target image and a color palette to be displayed; and a marking processing section which marks a region on the first target image and a region on the color palette in response to an input from a user, in response to the input from the user with respect to one of the region on the first target image and the region on the color palette, the other being marked.

A labeling method according to an example aspect of the present invention includes: causing a first target image to be displayed; causing a color palette to be displayed; marking a region on the first target image or a region on the color palette in response to an input from a user; and in response to the input from the user with respect to one of the region on the first target image and the region on the color palette, marking the other.

A labeling program according to an example aspect of the present invention causes a computer to carry out: a process of causing a first target image to be displayed; a process of causing a color palette to be displayed; a process of marking a region on the first target image or a region on the color palette in response to an input from a user; and a process of, in response to the input from the user with respect to one of the region on the first target image and the region on the color palette, marking the other.

A recording medium according to an example aspect of the present invention is a recording medium in which a labeling program for causing a computer to function as a labeling device is stored, the labeling program causing the computer to carry out: a process of causing a first target image to be displayed; a process of causing a color palette to be displayed; a process of marking a region on the first target image or a region on the color palette in response to an input from a user; and a process of, in response to the input from the user with respect to one of the region on the first target image and the region on the color palette, marking the other.

### Advantageous Effects of Invention

According to an example aspect of the present invention, it is possible to provide a labeling device, a labeling method, a labeling program, and a recording medium in which the labeling program is stored, each of which makes it possible for a user to efficiently label a region of a target object in an image.

### BRIEF DESCRIPTION OF DRAWINGS

FIG. 1 is a block diagram of a labeling device according to a first example embodiment of the present invention.

FIG. 2 is a conceptual diagram illustrating how a region in a target image is marked with use of the labeling device according to the first example embodiment of the present invention.

FIG. 3 is a conceptual diagram illustrating how a region in another target image is marked with use of the labeling device according to the first example embodiment of the present invention.

FIG. 4 is a conceptual diagram illustrating how labeling is carried out with respect to a target image with use of the labeling device in which data is accumulated.

FIG. 5 is a functional block diagram of the labeling device according to the first example embodiment of the present invention and a display device.

FIG. 6 is a common flowchart of a marking process carried out by the labeling device according to the first example embodiment of the present invention.

FIG. 7 is a flowchart of the marking process carried out with respect to the first target image by the labeling device according to the first example embodiment of the present invention.

FIG. 8 is a flowchart of the marking process carried out with respect to the second and subsequent target images by the labeling device according to the first example embodiment of the present invention.

FIG. 9 is a block diagram of a labeling device according to a second example embodiment of the present invention.

FIG. 10 is a conceptual diagram illustrating how regions in target images are marked with use of the labeling device according to the second example embodiment of the present invention.

FIG. 11 is a common flowchart of a marking process carried out by the labeling device according to the second example embodiment of the present invention.

FIG. 12 is a drawing illustrating an editing function of a labeling device according to another example embodiment of the present invention.

FIG. 13 is a drawing illustrating display of a color palette according to another example embodiment of the present invention.

FIG. 14 is a block diagram illustrating a case where a control section according to an example embodiment of the present invention is realized by software.

FIG. 15 is a block diagram illustrating a configuration of a labeling device according to an example embodiment of the present invention.

FIG. 16 is a flowchart of a labeling method (marking process) carried out with use of the labeling device illustrated in FIG. 15.

### EXAMPLE EMBODIMENTS

### First Example Embodiment

The following description will discuss a labeling device 100 according to a first example embodiment with reference to drawings. Note that an image which the labeling device 100 causes to be actually displayed is a color image. However, drawings of images described herein are black and white for convenience. A difference in hue or chroma is expressed by the sizes and density of dots in the drawings, and are also described verbally herein.

(Configuration of Labeling Device)

A configuration of the labeling device 100 is described with reference to a drawing. The labeling device 100 is a device for a user to efficiently create training data with use of which AI is trained. The training data is obtained by, in a target image which includes a target object to be recognized by the AI, labeling a region corresponding to the target object. In an example, the training data includes the target image and information indicating a position labeled in the target image. Note that, in the following example embodiments, an example in which the target object to be labeled is “rust” is described. However, the example embodiments are not limited such an example, and can be used to label a variety of target objects such as an oil spill on the sea.

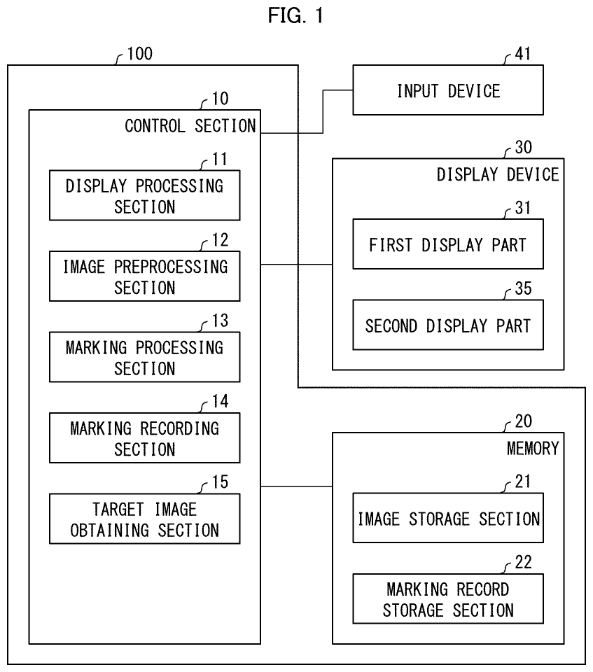

FIG. 1 is a block diagram of the labeling device 100 according to an example embodiment of the present invention. As illustrated in FIG. 1, the labeling device 100 includes a control section 10 and a memory 20. The control section 10 integrally controls the entire labeling device 100. In the memory 20, image data and marking data are stored. A display device 30 displays an image and a color palette on the basis of control carried out by the control section 10. An input device 41 accepts an input from the user, and outputs the input to the control section 10. The input device 41 can be an input device such as, for example, a touch pad, a touch panel, a mouse, or a keyboard. In case where the input device 41 is a touch panel, the input device 41 can serve also as the display device 30.

The control section 10 includes a display processing section 11, an image preprocessing section 12, a marking processing section 13, a marking recording section 14, and a target image obtaining section 15. The display processing section 11 causes the display device 30 to (i) set a first display part 31 and a second display part 35, (ii) display the target image (first target image, second target image) in the first display part 31, and (iii) display the color palette in the second display part 35. The image preprocessing section 12 preprocesses the target image. In response to an input from the user with respect to one of a region on the first target image and a region on the color palette, the marking processing section 13 marks the other. The marking processing section 13 will be described later in detail. The marking recording section 14 records, in the memory 20, data concerning the region that has been marked. The target image obtaining section 15 obtains the target image from the memory 20. The first display part 31 is an example of a first display region, and the second display part 35 is an example of a second display region.

Note that, here, a display region in which the target image is displayed is referred to as “first display part” for convenience, and a display region in which the color palette is displayed is referred to as “second display part” for convenience. Note also that although a configuration in which the target image and the color palette are displayed in the first display part 31 and the second display part 35, respectively, in the single display device is described here, the first display part 31 and the second display part 35 may not be set on an identical display device and may be displayed across a plurality of display devices.

Each section of the control section 10 may be realized with use of a dedicated processor such as an application specific integrated circuit (ASIC) or a programmable logic device (PLD). Alternatively, the entire control section 10 may be constituted by a single dedicated processor. Alternatively, a program corresponding to each section of the control section may be stored in advance in a read only memory (ROM) (not illustrated) in the memory 20, and then read and loaded in a random access memory (RAM) (not illustrated) in the memory so that a central processing unit (CPU) executes the program so as to function as each section of the control section 10.

The display processing section 11 preferably causes the first display part 31 and the second display part 35 to be displayed on a single display screen of the display device 30. By causing the first display part 31 and the second display part to be displayed on a single display screen, it becomes easy to compare a target image 321 and a color palette 36. This improves the efficiency of a marking operation.

The image preprocessing section 12 can, for example, cluster colors of the target image. Clustering is an operation to reduce the number of classifications of the colors of the target image. Color data concerning the target image has a given amount of information for each pixel. Since a marking process is basically carried out visually by the user, the amount of the information concerning the colors may be reduced. That is, it is possible to reduce the amount of the information concerning the colors by clustering colors which are similar to each other to such a degree that the user cannot distinguish the colors. By such preprocessing, it is possible to reduce the number of processes required for the marking process.

The memory 20 includes an image storage section 21 and a marking record storage section 22. In the image storage section 21, digital data concerning the target image is stored. The digital data is color data concerning pixels corresponding to the target image. The color data concerning the pixels is, for example, data which specifies each color of RGB with use of any of 256 gradations. In the marking record storage section 22, colors included in the region which is on the color palette and which the marking processing section 13 has previously marked are accumulated and stored. Specifically, stored are (i) data indicating the positions of pixels corresponding to the region which is on the target image and which the marking processing section 13 has marked and (ii) data indicating the colors of the region which is on the color palette and which the marking processing section 13 has marked. The data indicating the positions of the pixels corresponding to the region which is on the target image and which the marking processing section 13 has marked can be regarded as information indicating positions labeled in the target image, and can make up the training data together with the target image. Note that the memory 20 may include a ROM or a RAM in addition to these sections as necessary.

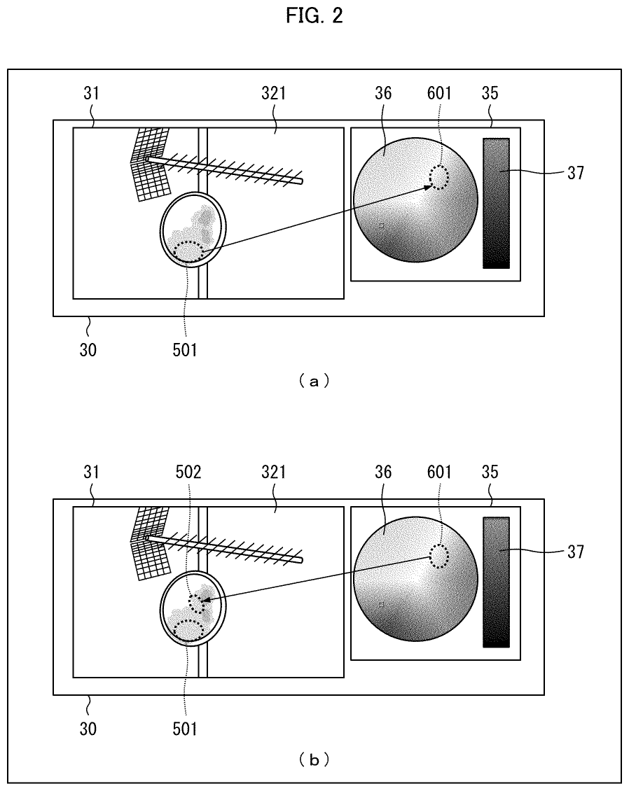

As illustrated in FIG. 2, the display processing section 11 causes (i) a target image 32i (i indicates the ordinal number of the target image, and, in FIG. 2, target image 321), which the target image obtaining section 15 has obtained, to be displayed in the first display part 31 of the display device 30 and (ii) the color palette 36 and an auxiliary bar 37 to be displayed in the second display part 35 of the display device 30. The target image 321 is an image with respect to which the user carries out labeling so as to create the training data. In the first example embodiment, the region to be labeled is a region in which rust occurs, and the target image 321 is an image including regions in each of which rust occurs.

The color palette 36, which is a color space, in the first example embodiment is, for example, a Lab color space. The Lab color space is a circular color system in which hues of green, blue, red, and yellow are arranged in a circumferential direction, and chroma of green, blue, red, and yellow is arranged in a radial direction. The auxiliary bar 37 in the first example embodiment shows lightness. There may be no auxiliary bar 37. Note that a display format of the color palette 36 is not limited to such an example color system. As the color palette 36, a single color palette 36 is used for all target images.

(Marking Processing Section)

Next, the marking processing section 13 is described in detail with reference to drawings. FIG. 2 is a conceptual diagram illustrating how the region of the target object in the target image 321 is marked with use of the labeling device 100. The target image 321 is an image in which an antenna is captured. Red rust spreads with gradations on a parabolic antenna of the antenna. A case where this region of the red rust is marked is described.

As illustrated in FIG. 2A, the marking processing section 13 marks a region 501 on the target image 321 in response to an input from the user. Note that “marks a region” here means that the user selects the region on the target image 321. Hereinafter, these operations conducted by the user and the marking processing section 13 are also referred to as “the user marks a region”. Note that, as marking, it is unnecessary to select the entire region of the target object at once, and a part of the region may be selected. On the single target image 321, marking can be carried out repeatedly.

How the user selects the region 501 is not limited. For example, the user may specify an extension of the region 501 via the input device 41. Alternatively, the user may use a graphic tool capable of defining any range on the image.

The display processing section 11 causes the region 501 which has been marked to be displayed in such a manner as to be superimposed on the target image. How the display processing section 11 causes the region 501 to be displayed is not limited. For example, as illustrated in FIG. 2A, the region 501 may be enclosed by a dotted line, or the region 501 may be made bright. Data indicating the positions of pixels corresponding to the region 501 which the user has marked is recorded (written) and stored in the marking record storage section 22 by the marking recording section 14.

The marking processing section 13 further marks a region 601 which is on the color palette 36 and which corresponds to colors included in the region 501 that is on the target image 321 and that the user has marked. Note that “marks a region” here means that the marking processing section 13 selects the region 601 of colors on the color palette 36. Hereinafter, this operation conducted by the marking processing section 13 is also referred to as “the marking processing section 13 marks a region”. Data indicating the colors included in the region 601 which has been marked on the color palette 36 is recorded and stored in the marking record storage section 22 by the marking recording section 14.

On the contrary, as illustrated in FIG. 2B, in a case where the user marks the region 601 on the color palette 36 (in this case, selects the region 601 which has already been marked), the marking processing section 13 marks the region 601 on the color palette 36 in response to the input from the user. The marking processing section 13 further marks the region 501 and a region 502 each of which is on the target image 321 and each of which corresponds to the colors included in the region 601 that the user has marked. That is, the regions 501 and 502 each of which includes colors corresponding to the colors included in the region 601 that the user has marked on the color palette 36 are displayed on the target image 321. Data indicating the positions of pixels corresponding to the regions 501 and 502 that have been displayed is recorded and stored in the marking record storage section 22 by the marking recording section 14. In FIG. 2B, the reason why a region which corresponds to the colors included in the region 601 is displayed at two parts, i.e., the regions 501 and 502 is that the rust having the same hues occurs at the two parts. In so doing, the display processing section 11 may cause at least one of such a partial image region and a color region, each of which is marked by the marking processing section 13, to be displayed in a highlighted manner, as shown by 501 and 601 illustrated in FIG. 2.

Note that one or both of the following (i) and (ii) as described above may be restricted in response to an input from the user: (i) the marking processing section 13 marks the region 601 which is on the color palette 36 and which corresponds to the colors included in the region 501 that has been marked on the target image 321 in response to the input from the user; and (ii) the marking processing section 13 marks the region 502 which is on the target image 321 and which corresponds to the colors included in the region 601 that has been marked on the color palette 36 in response to the input from the user.

This restriction may be applied to an entire series of operations in advance, or may be inputted by the user each time the user marks the region. With this configuration, it is possible for the user to select whether or not a result of the user's marking in one of the display regions is reflected to the other of the display regions, depending on the progress of an operation or the user's decision. By thus changing setting in accordance with the user's intention, it is possible to efficiently carry out the marking operation.

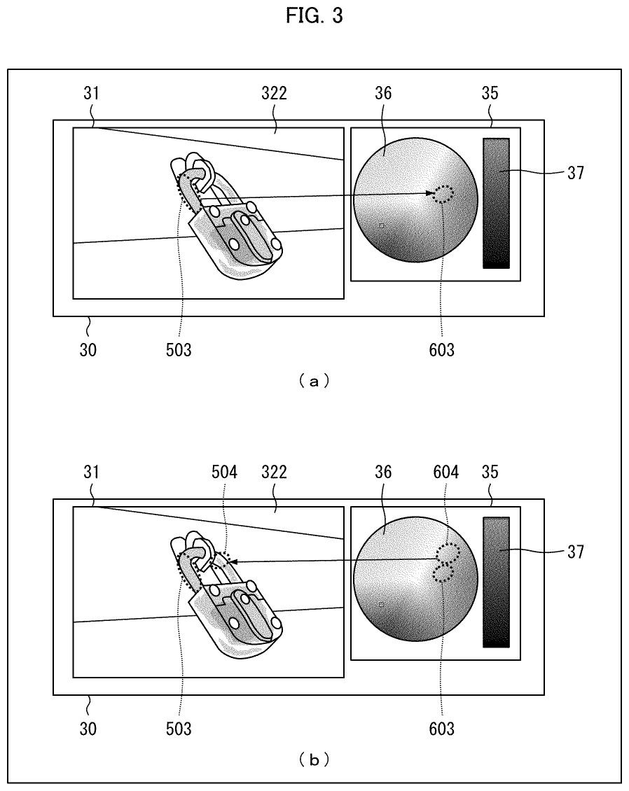

FIG. 3 is a conceptual diagram illustrating how a region in another target image 322 is marked. The target image 322 is an image including a lock on which red rust occurs. As illustrated in FIG. 3A, the user marks, on the target image 322 displayed in the first display part 31, a region 503 of the rust, which is a region of the target object. Then, a region 603 which corresponds to colors included in the region 503 is marked on the color palette 36. Data concerning colors included in the region 603 is recorded and stored in the marking record storage section 22 by the marking recording section 14.

Further, as illustrated in FIG. 3B, in a case where the user marks a region 604, which differs from the region 603, on the color palette 36, a region 504 which corresponds to colors included in the region 604 is marked on the target image 322. Data concerning the colors included in the region 604 is recorded and stored in the marking record storage section 22 by the marking recording section 14. Data concerning the positions of pixels corresponding to the region 504 is recorded and stored in the marking record storage section 22 by the marking recording section 14. In this manner, the user can not only select the region which has already been marked, but also newly mark, on the color palette 36, the region 604 which has hues that are considered to indicate a rust region.

The user repeats operations as described above so that the marking process is carried out with respect to a plurality of target images 32i each including a rust image. Accordingly, colors included in a plurality of regions which have been marked on one or more previous target images 32i are accumulated and stored in the marking record storage section 22. In a case where (i) the target image obtaining section 15 obtains a new target image (second target image) 32i with respect to which marking has not yet been carried out and (ii) the display processing section 11 causes the second target image 32i and the color palette 36 to be displayed, the display processing section 11 may cause the colors to be displayed in the single color palette 36, the colors being included in the plurality of regions that have been marked on the one or more target images and being accumulated and stored in the marking record storage section 22. Further, the marking processing section 13 can mark, on the second target image 32i, a region which corresponds to colors included in a region that is on the color palette 36 and that the marking processing section 13 has previously marked. Use of this function allows a reduction in burden on the user when the user carries out marking with respect to the second target image 32i. This method is described below.

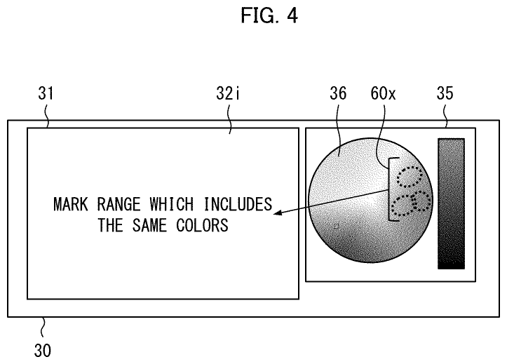

FIG. 4 is a conceptual diagram illustrating how labeling is carried out with respect to the second target image 32i with use of the labeling device 100 in which data is accumulated. First, the target image obtaining section 15 obtains the second target image 32i with respect to which marking has not yet been carried out. The display processing section 11 causes the second target image 32i to be displayed in the first display part 31. The display processing section 11 causes all colors to be displayed in the second display part 32 in such a manner as to be superimposed on the color palette 36, the colors being included in a plurality of regions 60X and having already been stored in the marking record storage section 22. In a case where the user selects all of the regions 60X and causes the colors included in the regions 60X to be reflected to the target image 32i, a region which includes the same colors as the colors included in the regions 60X is marked on the target image 32i. Since the marking processing section 13 marks a rust region in the target image 32i, the burden on the user is reduced.

A rust image does not have a clear boundary. Therefore, it is a heavy burden on the user for the user to label ranges of a large number of rust images. However, it can be determined that, in a region which has hues similar to those in a region of the rust image, similar rust occurs. Therefore, as described above, by the user marking a rough region of rust and causing the marking processing section 13 to mark a region which has hues similar to those in the region, it is possible to reduce the burden of a labeling operation on the user.

Further, according to the above configuration, it is possible to carry out marking with respect to the second target image with use of previously accumulated marking colors. Therefore, as more marking colors are accumulated, generalization performance increases, and accordingly it is possible to realize an improvement in accuracy of marking, a reduction in time required for the labeling operation, and a reduction in time required for correction of marking colors.

(Functions of Labeling Device)

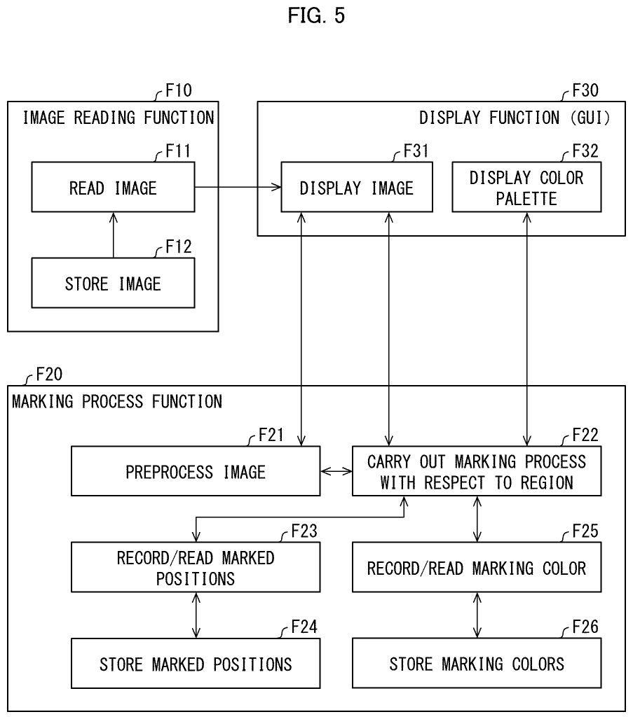

The functions of the labeling device 100 and the display device 30 described above are described with reference to a drawing. FIG. 5 is a functional block diagram of the labeling device 100 and the display device 30. As illustrated in FIG. 5, the labeling device 100 has an image reading function F10 and a marking process function F20. The display device 30 has a display function F30. Note that arrows illustrated in FIG. 5 each mainly indicate a direction of a flow of a signal or data, and a unidirectional arrow does not exclude the bidirectionality of a signal or data.

The image reading function F10 includes: a function F11 of reading a target image which has been stored and then causing the target image to be displayed in the first display part 31; and a function F12 of storing the target image which is read by the function F11. That is, the function F12 defines a storage location of the target image. The marking process function F20 includes: a function F21 of preprocessing the target image which has been displayed; a function F22 of carrying out a marking process with respect to a region which has been selected on the target image or a color palette; a function F23 of recording and reading positional information concerning pixels corresponding to the region which has been marked on the target image; a function F24 of storing the positional information which is recorded and read by the function 23; a function F25 of recording and reading color information concerning pixels corresponding to the region which has been marked on the color palette; and a function F26 of storing the color information which is recorded and read by the function 25. That is, the function F24 builds a database of the positional information, and the function F26 indicates a database of the color information. The display function F30 includes a function F31 of displaying the target image and a function F32 of displaying the color palette.

The target image obtaining section 15 and the display processing section 11 have the function F11 of reading a target image and causing the target image to be displayed in the first display part 31. The image storage section 21 has the function F12 of storing the target image. The image preprocessing section 12 has the function F21 of preprocessing the target image. The marking processing section 13 has the function F22 of carrying out a marking process. The marking recording section 14 has the function F23 of recording and reading positional information concerning pixels and the function F25 of recording and reading color information concerning pixels. The marking record storage section 22 has the function F24 of storing the positional information and the function F26 of storing the color information. The first display part 31 has the function F31 of displaying the target image. The second display part 35 has the function F32 of displaying the color palette.

As has been described, the labeling device 100 according to the first example embodiment employs a configuration in which the labeling device 100 includes: a display processing section which causes a target image to be displayed in a first display region and causes a color palette to be displayed in a second display region; and a marking processing section which marks a region on the target image or a region on the color palette in response to an input from a user, the marking processing section marking a region which is on the color palette and which corresponds to colors included in the region that has been marked on the target image in response to the input from the user, and marking a region which is on the target image and which corresponds to colors included in the region that has been marked on the color palette in response to the input from the user. Therefore, the labeling device 100 according to the first example embodiment has the effect that it is possible for a user to efficiently label a region of a target object in a target image.

(Labeling Method)

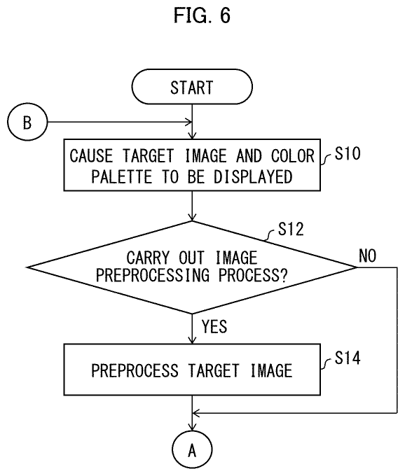

Next, a flow of a labeling method M100 is described with reference to drawings. FIG. 6 is a flowchart of preprocessing in the labeling method M100 (marking process) carried out with use of the labeling device 100 according to the first example embodiment.

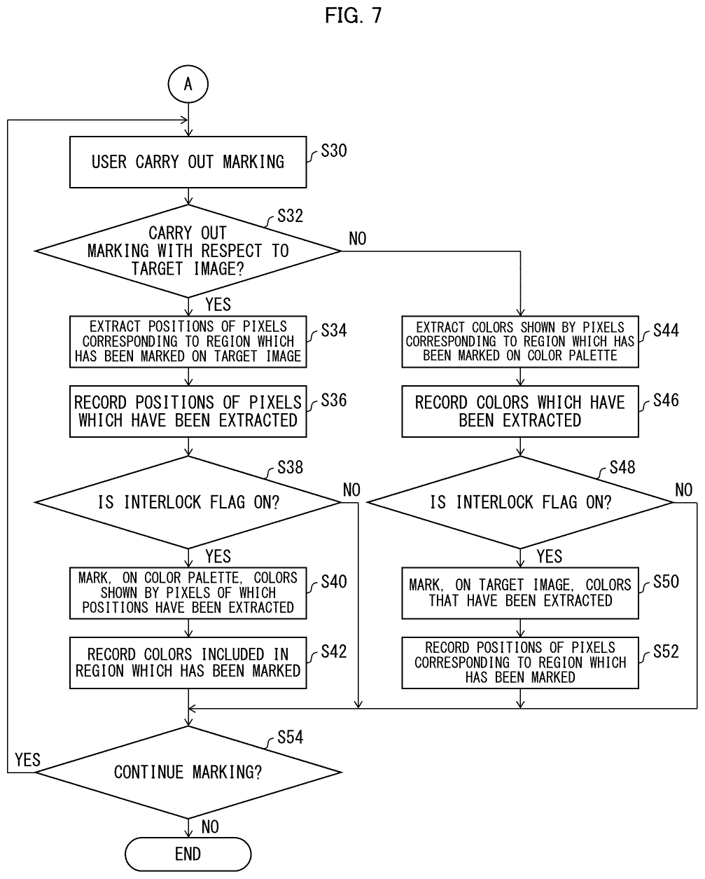

First, the target image obtaining section 15 obtains a first target image 321, and the display processing section 11 causes the first target image 321 to be displayed in the first display part 31. The display processing section 11 also causes a color palette 36 to be displayed in the second display part 35 (step S10). Next, the image preprocessing section 12 determines whether or not to preprocess the target image 321 (step S12). Whether or not the image preprocessing section 12 carries out preprocessing is preferably common to processing of a series of target images 32i. That is, in a case where the image preprocessing section 12 carries out the preprocessing, the image preprocessing section 12 preprocesses all of the target images 32i. In a case where the image preprocessing section 12 does not carry out the preprocessing, the image preprocessing section 12 preferably does not preprocess any of the target images 32i. Whether or not the image preprocessing section 12 preprocesses the target images 32i may be specified in advance by a user, or may be specified with respect to each target image 321 by the user. In a case where it is determined, in the step S12, that the preprocessing is carried out (step S12: YES), the marking process proceeds to a step S14, in which the image preprocessing section 12 preprocesses the target image 321. Subsequently, the marking process proceeds to a step S30 illustrated in FIG. 7. In a case where it is determined, in the step S12, that the preprocessing is not carried out (step S12: NO), the marking process directly proceeds to the step S30 illustrated in FIG. 7.

FIG. 7 is a flowchart which illustrates the marking process carried out with respect to the first target image 321 and which follows FIG. 6. In the step S30 illustrated in FIG. 7, the user carries out marking with respect to the target image 321 or the color palette 36. Next, in a step S32, the marking processing section 13 determines whether or not to carry out marking with respect to the target image 321. Specifically, the marking processing section 13 determines whether or not the user has conducted an operation to carry out marking with respect to the target image 321. In a case where the marking processing section 13 determines to carry out marking with respect to the target image 321 (step S32: YES), the marking process proceeds to a step S34, in which the marking processing section 13 extracts the positions of pixels corresponding to a region which has been marked on the target image 321. Next, the marking process proceeds to a step S36, in which the marking recording section 14 records, in the marking record storage section 22, the positions of the pixels which have been extracted.

The marking process then proceeds to a step S38, in which the marking processing section 13 determines whether or not an interlock flag is on. The interlock flag is a flag indicating whether or not the above-described process of bidirectionally reflecting marking is restricted, i.e., whether or not one or both of the following (i) and (ii) are restricted: (i) the marking processing section 13 marks a region 601 which is on the color palette 36 and which corresponds to colors included in a region 501 that has been marked on the target image 321 in response to an input from the user; and (ii) the marking processing section 13 marks a region 502 which is on the target image 321 and which corresponds to colors included in the region 601 that has been marked on the color palette 36 in response to an input from the user. This flag can be set to be on or off, for example, by the user. In a case where the interlock flag is on, the above-described process of bidirectionally reflecting marking is not restricted. In a case where the interlock flag is off, the above-described process of bidirectionally reflecting marking is restricted. The interlock flag is recorded in, for example, the memory 20.

In a case where the marking processing section 13 determines that the interlock flag is on (step S38: YES), the marking process proceeds to a step S40, in which the marking processing section 13 marks, on the color palette 36, colors shown by the pixels which have been extracted. Next, the marking process proceeds to a step S42, in which the marking recording section 14 records, in the marking record storage section 22, colors which have been marked. The colors recorded in the marking record storage section 22 are stored as marking information (hereinafter, the marking information concerning the colors will be also referred to as “marking colors”). Next, the marking process proceeds to a step S54. Note that in a case where, in the step S38, the marking processing section 13 determines that the interlock flag is off (step S38: NO), the marking process directly proceeds to the step S54.

In a case where, in the step S32, the marking processing section 13 determines that the user has carried out marking with respect to the color palette 36 (step S32: NO), the marking process proceeds to a step S44, in which the marking processing section 13 extracts colors shown by pixels which have been marked on the color palette 36. Next, the marking process proceeds to a step S46, in which the marking recording section 14 records, in the marking record storage section 22, the colors which have been extracted.

The marking process then proceeds to a step S48, in which the marking processing section 13 determines whether or not the interlock flag is on. In a case where the marking processing section 13 determines that the interlock flag is on (step S48: YES), the marking process proceeds to a step S50, in which the marking processing section 13 marks, on the target image 321, the colors that have been extracted. Next, the marking process proceeds to a step S52, in which the marking recording section 14 records, in the marking record storage section 22, the positions of pixels corresponding to the region which has been marked on the target image 321. Next, the marking process proceeds to the step S54. Note that in a case where, in the step S48, the marking processing section 13 determines that the interlock flag is off (step S48: NO), the marking process directly proceeds to the step S54.

Next, in the step S54, the marking processing section 13 determines whether or not to continue marking. Specifically, the marking processing section 13 determines whether or not the user has conducted an operation to carry out marking with respect to the same target image 321. In a case where the marking processing section 13 determines to continue marking (step S54: YES), the marking process proceeds to the step S30. In a case where the marking processing section 13 determines not to continue marking (step S54: NO), the marking process with respect to the first target image 321 ends. A case where marking is not continued is, for example, a case where the user has selected a second target image 322 and caused the target image 322 to be displayed in the first display part 31.

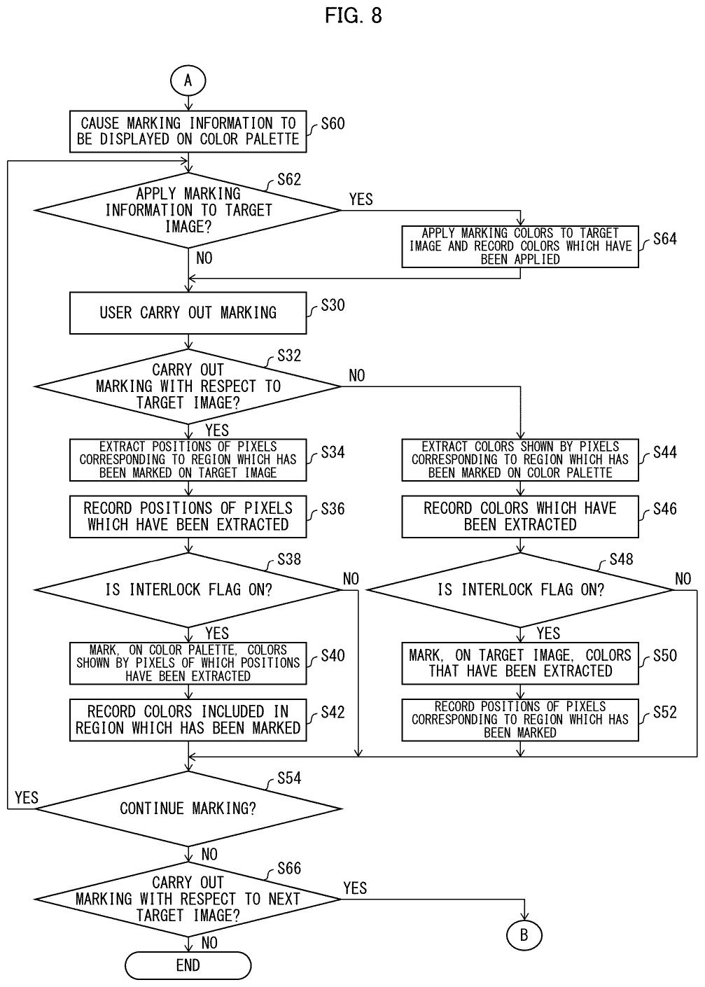

Next, the marking process carried out with respect to the second target image 322 is described with reference to drawings. The following description also applies to the marking process carried out with respect to target images 32i subsequent to the second target image 322. As in the marking process carried out with respect to the first target image, the flow illustrated in FIG. 6 is first carried out. FIG. 8 is a flowchart which illustrates the marking process carried out with respect to the second target image 322 and the subsequent target images and which follows FIG. 6.

In a step S60 illustrated in FIG. 8, the marking processing section 13 causes the marking information (marking colors) to be displayed on the color palette 36. As described above, the marking information indicates the colors which have been stored in the marking record storage section 22 and which indicates the colors included in the region that the user has marked on the target image 321. Next, in a step S62, the marking processing section 13 determines whether or not to apply (reflect) the marking information to the target image 322. Specifically, the marking processing section 13 determines whether or not the user has conducted an operation to apply the marking information to the target image 322.

In a case where the marking processing section 13 determines to apply the marking information to the target image 322 (step S62: YES), the marking process proceeds to a step S64, in which the marking processing section 13 applies (marks) the marking colors to the target image 322, and the marking recording section 14 records, in the marking record storage section 22, colors which have been applied (marked).

After the step S64 or in a case where, in the step S62, the marking processing section 13 determines not to apply the marking information to the target image 322 (step S62: NO), the marking process proceeds to the step S30. Thereafter, the same steps as the steps S30 through S54 described with reference to FIG. 7 are carried out. The steps S30 through S54 are as described with reference to FIG. 7, and are therefore not described here.

In a case where, in the step S54, the marking processing section 13 determines not to continue marking (step S54: NO), the marking process proceeds to a step S66, in which the marking processing section 13 determines whether or not to carry out marking with respect to a next target image. In a case where the marking processing section 13 determines to carry out marking with respect to a next target image, i.e., in a case where the user has selected the next target image (step S66: YES), the marking process proceeds to the step S10 illustrated in FIG. 6, and then the steps illustrated in FIGS. 6 and 8 are repeated. In a case where the user does not carry out marking with respect the next target image and an end condition is satisfied (step S66: NO), the marking process ends. A case where the end condition is satisfied is a case where the user has selected end of the marking process, a case where a power source is turned off, or the like. Note that in a case where, in the step S54, the marking processing section 13 determines to continue marking (step S54: YES), the marking process proceeds to the step S62.

By repeating the above-described marking process with respect to many target images 32i, the marking information is accumulated in the marking record storage section 22. In a case where the marking information is accumulated in a sufficiently large amount, the user does not need to carry out marking with respect to the second target image 32i by himself/herself. Instead, by the user applying the marking information to the second target image 32i, the target image 32i in which a region of a target object is marked is created.

In the marking record storage section 22, colors included in a region which is on the color palette 36 and which the marking processing section 13 has previously marked can be stored in association with any identification information. For example, in the marking record storage section 22, the colors included in the region which is on the color palette 36 and which the marking processing section 13 has previously marked can be stored with a specific name. The marking processing section 13 may mark, on a second target image which the target image obtaining section 15 has obtained, a region which corresponds to the colors that are stored in association with the specific name (identification information) in the marking record storage section 22. This makes it possible to store previously accumulated marking colors in association with any identification information, and carry out marking with respect to the second target image with use of marking colors stored in association with specific identification information, among the previously accumulated marking colors. Thus, it is possible to apply appropriate marking colors. Also, for example, it is possible to carry out a plurality of types of marking in parallel.

As has been described, the labeling method M100 according to the first example embodiment employs a configuration in which the labeling method M100 includes: causing a target image to be displayed in a first display region and causing a color palette to be displayed in a second display region; and marking a region on the target image or the color palette in response to an input from a user, in this marking, a region which is on the color palette and which corresponds to colors included in the region that has been marked on the target image in response to the input from the user being marked, and a region which is on the target image and which corresponds to colors included in the region that has been marked on the color palette in response to the input from the user being marked. Therefore, the labeling method M100 according to the first example embodiment has the effect that it is possible for a user to efficiently label a region of a target object in a target image.

### Second Example Embodiment

The following description will discuss a labeling device 200 according to a second example embodiment of the present invention with reference to drawings. Note that constituent elements having the same functions as those described in the first example embodiment are denoted by the same reference numerals, and descriptions thereof will be omitted as appropriate. As illustrated in FIG. 9, a configuration of the labeling device 200 is basically the same as that of the labeling device 100. The labeling device 200 differs from the labeling device 100 in that, in the labeling device 200, a control section includes a target range specifying section 16.

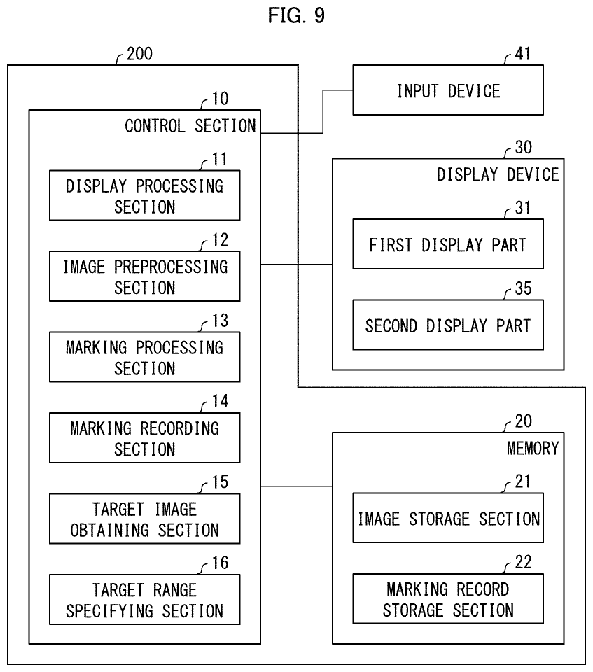

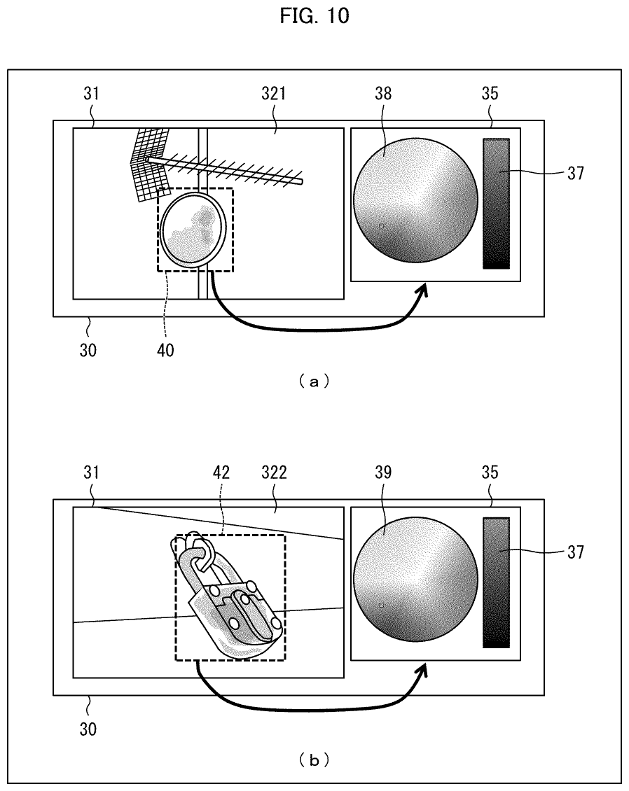

The target range specifying section 16 specifies a target range from a target image. FIG. 10 is a conceptual diagram illustrating how regions of a target object in target images 321 and 322 are marked with use of the labeling device 200 according to the second example embodiment. As illustrated in FIG. 10A, the target range specifying section 16 extracts, from the target image 321, a range of an object (parabolic antenna) in which red rust occurs, as a target range 40. As illustrated in FIG. 10B, the target range specifying section 16 extracts, from the target image 322, a range of an object (lock) in which red rust occurs, as a target range 42. The target range specifying section 16 may specify the target range in response to an input of coordinates from a user. Further, the target range specifying section 16 may, for example, (i) detect a specific object (parabolic antenna, lock, or the like) from the target image with use of an object detection algorithm, such as a trained model or pattern matching that has been trained in advance so as to detect the specific object, and (ii) specify the target range in accordance with a result of the detection. For example, the target range specifying section 16 may specify, as the target range, a rectangular region including a region in which a specific object (parabolic antenna, lock, or the like) has been detected. Further, the target range specifying section 16 may, for example, extract the target range in accordance with a condition of a target (iron, metal, or the like) or a color (red-brown color or the like) which condition has been inputted by the user. This makes it possible for a display processing section 11 to cause the target range, which the target range specifying section 16 has extracted or specified, to be displayed.

Further, in the second example embodiment, the display processing section 11 constitutes a color palette from colors included in the target range which the target range specifying section 16 has specified. Specifically, the display processing section 11 generates a color palette 38 with use of colors included in the target range 40 which has been extracted. The display processing section 11 also generates a color palette 39 with use of colors included in the target range 42 which has been extracted.

In a subsequent marking process, a marking processing section 13 marks only a region within the target range. Thus, even in a case where a region which corresponds to colors included in a region that has been marked on the color palette in response to an input from the user is present outside the target region (for example, a part having the same colors as rust is accidentally present in the background), it is possible to prevent the marking processing section 13 from marking an improper region.

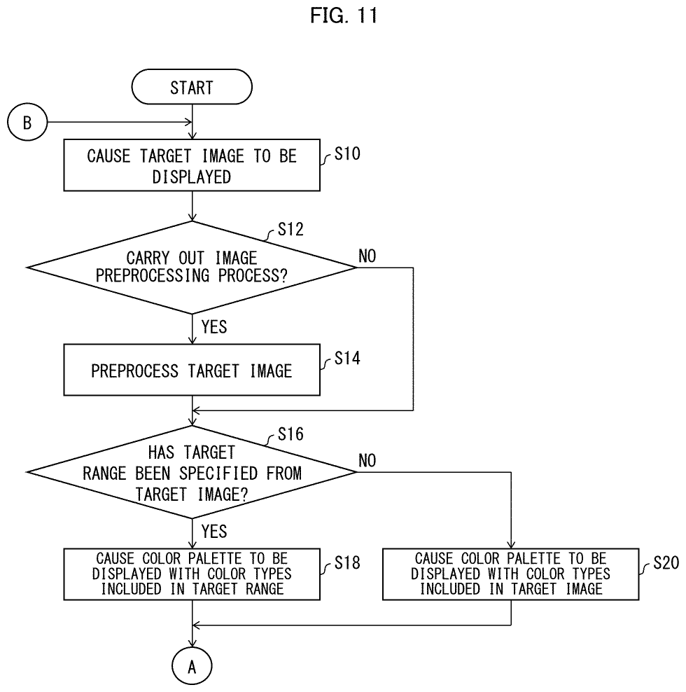

Next, a flow of a labeling method M200 according to the second example embodiment is described with reference to drawings. FIG. 11 is a flowchart of preprocessing in a marking process carried out with use of the labeling device 200 according to the second example embodiment. Steps S10 through S14 in the labeling method M200 illustrated in FIG. 11 are the same as the flow of the preprocessing in the steps S10 through S14 in the labeling method M100 illustrated in FIG. 6, and therefore descriptions thereof are omitted.

In a step S16, the marking processing section 13 determines whether or not the target range specifying section 16 has specified a target range from a target image. In a case where the marking processing section 13 determines that the target range specifying section 16 has specified a target range from the target image (step S16: YES), the flow of the preprocessing proceeds to a step S18. In the step S18, the display processing section 11 generates a color palette 38 with use of color types included in the target range and causes the color palette 38 to be displayed. In a case where the marking processing section 13 determines that the target range specifying section 16 has not specified a target range from the target image (step S16: NO), the flow of the preprocessing proceeds to a step S20. In the step S20, the display processing section 11 generates a color palette 36 with use of color types included in the entire target image and causes the color palette 36 to be displayed. Next, in a case where the first target image is processed, the marking process proceeds to a step S30 illustrated in FIG. 7. In a case where the second and subsequent target images are processed, the marking process proceeds to a step S30 illustrated in FIG. 8. Subsequent steps are as described with reference to FIG. 7 or 8, except that the marking processing section 13 marks only a region within the target range.

As described above, by setting a target range from a target image, it is possible to narrow down color types included in the target range. Therefore, it is possible to generate a color palette having fine gradations of colors. By carrying out marking with use of this color palette, it is possible to accumulate marking information in which a detailed boundary of colors is defined. Therefore, in addition to the effect brought about by the first example embodiment, it is possible to bring about the effect that it is possible to label a region of a target object with high accuracy.

Note that, in a case where different target ranges are set in different target images, color palettes are created for the respective target images. However, marking information recorded via each color palette can be displayed on a single color palette including all colors (standard color palette). Therefore, by applying all pieces of marking information displayed on the standard color palette to a second target image and carrying out marking, it is possible for a user to easily carry out a labeling operation.

Moreover, as described above, in the marking process, the marking processing section 13 marks only a region within the target range and does not mark a region outside the target range, so that even in a case where a region which corresponds to colors included in a region that has been marked on the color palette in response to an input from the user is present outside a target region, it is possible to prevent the marking processing section 13 from marking an improper region.

[Variations]

(First Variation: Editing Function)

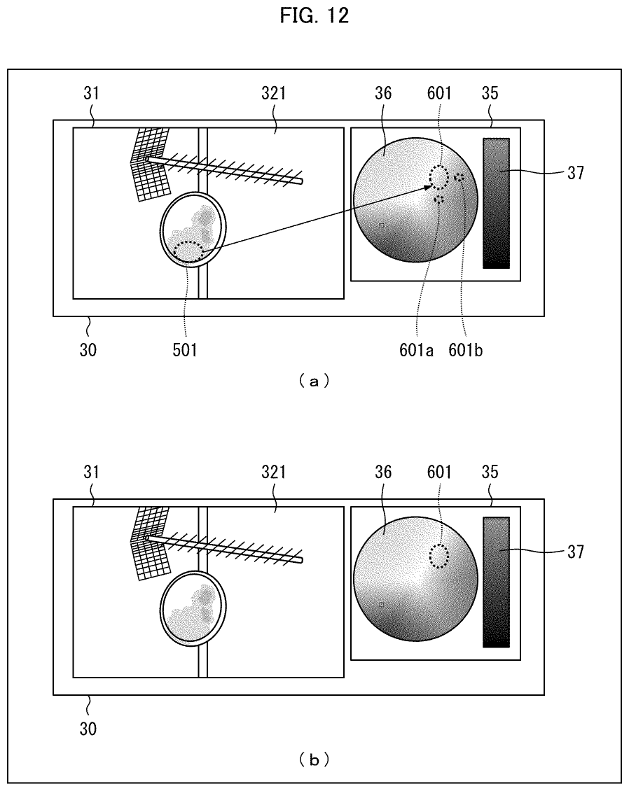

As a variation, functions which the labeling devices 100 and 200 may each include are described below. The labeling devices 100 and 200 may be each able to edit a region which has been marked. Editing may be carried out by a user, or may be carried out by the marking processing section. FIG. 12 is a drawing illustrating an editing function of a labeling device according to another example embodiment of the present invention.

For example, on a target image 321, a user marks a continuous region. Colors included in the continuous region of rust gently vary in hue or chroma. A color palette 36 is also a hue circle having gradations. Thus, in a case where the colors included in the region that the user has marked on the target image 321 are marked on the color palette 36, the region is also a region which is continuous to some extent. However, for example, as illustrated in FIG. 12A, there may be a case where colors of a region which is not a region of rust (colors which differ in hue from those of the rust), i.e., noises are mixed in a region 501 that the user has marked on the target image 321. The noises are marked, on the color palette 36, as outlier regions 601a and 601b.

In such a case, the user can delete the regions 601a and 601b which have been marked. Specifically, the user selects the outlier regions 601a and 601b on the color palette 36, and presses a delete button. This, as illustrated in FIG. 12B, makes it possible to delete only the regions 601a and 601b, while leaving a region 601 as it is.

The marking processing section 13 may be set so as to delete an outlier region which satisfies a given condition, even without an instruction from the user. The given condition is that a value of an area is equal to or less than a given value, that the position of the outlier region is apart from the main region 601 by a given distance or more, or the like.

Further, for example, a plurality of regions which have been marked on the target image 321 are marked as a plurality of regions on the color palette 36. In a case where the user determines that each of the plurality of regions on the color palette 36 is a part of a large rust region, the user may carry out editing for integrating the plurality of regions. In response to an instruction from the user, the marking processing section 13 integrates the plurality of regions into a single region. This makes it possible to completely mark, on the color palette 36, regions which are considered to be each a rust image. In a case where regions are integrated, an integration process is preferably carried out so that the contour of a region obtained by integration become smooth.

In addition, in a case where, when a region which has been marked on the color palette 36 is marked on the target image 321, a part which is clearly not a region of a target object is marked, it is possible to delete only marking of the region. This makes it possible to remove marking which has been carried out with respect to a wrong region.

By having the above-described functions, it is possible to delete a region which has been marked on a color palette and which is not considered to be a region of a target object or a region which has been marked on a target image and which is not a region of the target object. Furthermore, it is possible to integrate a plurality of regions into a continuous region on the color palette. Note that setting may be carried out so that a result of editing carried out on one screen is not reflected on the other screen.

(Second Variation: Weighting Function)

The marking processing section 13 may have a function of assigns weights to colors stored in the marking record storage section 22 and marking a region on a second target image on the basis of the weights.

As a weighting method, for example, the numbers of times respective colors have been marked on a color palette can be used as indices of weighting. In a case where the numbers of times respective colors have been marked on a plurality of target images are summed, it is highly probable that colors which have been marked more times are colors indicating a region of a target object which the user seeks. On the contrary, it can be determined that colors which have been marked fewer times are noises. Thus, the marking processing section 13 weights colors stored in the marking record storage section 22 on the basis of the numbers of times the respective colors have been marked. For example, the marking processing section 13 sets a certain number of times as a threshold, and specifies colors which have each been marked a number of times equal to or higher than the threshold, among the colors stored in the marking record storage section 22. Then, in a case where the marking processing section 13 carries out labeling with respect to a second target image, the marking processing section 13 can carry out marking with high accuracy by marking a region which corresponds to the colors that have been specified as having each been marked a number of times equal to or higher than the threshold. Note that the weighting is not limited to a method based on the number of times.

The display processing section 11 may cause the colors, to which the respective weights have been assigned, to be displayed in a ranking format or may cause only several top-ranked ones of the colors to be displayed, on the basis of the weights.

(Third Variation: Collective Marking Function)

The marking processing section 13 may have a function of collectively carrying out labeling with respect to target images with respect to which labeling has not yet been carried out. In a case where a marking process is carried out with respect to a large number of target images and marking information is accumulated, a user does not need to carry out the marking process with respect to second target images thereafter. In this case, the marking processing section 13 may have a function of sequentially carrying out marking with respect to a plurality of target images which the user has collectively specified. Such a configuration makes it unnecessary for the user to carry out marking with respect to the plurality of target images one by one with use of the marking information, so that it is possible to improve the efficiency of a labeling operation.

That is, the target image obtaining section 15 may be configured to obtain a plurality of second target images, and the marking processing section 13 may be configured to mark, on each of the plurality of second target images which the target image obtaining section 15 has obtained, a region which corresponds to colors stored in the marking record storage section 22.

(Fourth Variation: Display Format of Color Palette)

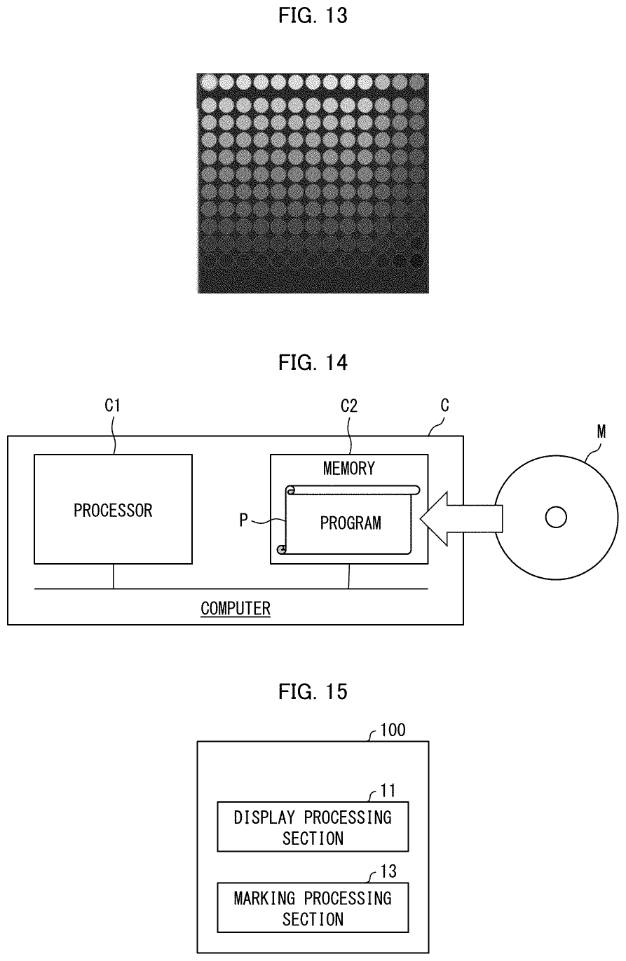

The display processing section 11 may have a function of selecting a display format of a color palette and causing the color palette to be displayed in the display format that has been selected. In each of the above-described first and second example embodiments, a Lab color space is displayed as an example of the color palette. However, the display format of the color palette is not limited thereto. FIG. 13 is a drawing illustrating display of a color palette according to another example embodiment. As illustrated in FIG. 13, for example, the display format may be such that hues are arranged in a horizontal direction and chroma is arranged in a vertical direction. In this manner, it is possible to prepare any display format in which arrangement is made on the basis of two or more elements selected from hues, chroma, and lightness. Then, by configuring the color palette such that the display format thereof can be selected from a plurality of display formats, it is possible for a user to select a display format in which the user can easily mark a region of a target object.

### Third Example Embodiment

The following description will discuss another example embodiment of the present invention. Note that members having the same functions as those described in the above example embodiments are denoted by the same reference numerals, for convenience.

(Labeling Device)

FIG. 15 is a block diagram illustrating a configuration of a labeling device 100 according to a third example embodiment of the present invention. As illustrated in FIG. 15, the labeling device 100 includes a display processing section 11 and a marking processing section 13.

The display processing section 11 causes a target image to be displayed in a first display region and causes a color palette to be displayed in a second display region. The marking processing section 13 marks a region on the target image and a region on the color palette in response to an input from a user. The marking processing section 13 further marks a region which is on the color palette and which corresponds to colors included in the region that has been marked on the target image in response to the input from the user, and marks a region which is on the target image and which corresponds to colors included in the region that has been marked on the color palette in response to the input from the user.

According to the above configuration, it is possible for the marking processing section 13 to reflect, also on a color palette, a result of marking carried out on a target image in response to an input from a user, and possible to reflect, also on the target image, a result of marking carried out on the color palette in response to the input from the user. That is, it is possible for the marking processing section 13 to bidirectionally reflect marking of regions on the target image and the color palette carried out in response to an input from the user. This makes it possible for the user to efficiently label a region of a target object in the image.

(Labeling Method)

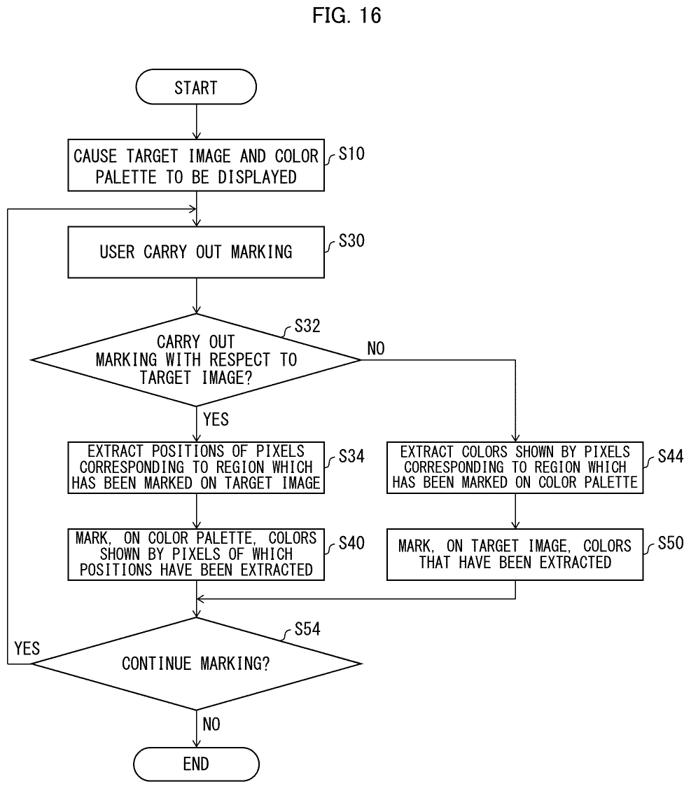

Next, a flow of a labeling method M100 is described with reference to a drawing. FIG. 16 is a flowchart of a labeling method M100 (marking process) carried out with use of the labeling device 100 according to the third example embodiment.

First, the display processing section 11 causes a target image to be displayed in a first display region and causes a color palette to be displayed in a second display region (step S10).

Next, the marking processing section 13 marks a region on the target image or the color palette in response to an input from a user (step 30). Next, in a step S32, the marking processing section 13 determines whether or not the user has carried out marking with respect to the target image. In a case where the marking processing section 13 determines that the user has carried out marking with respect to the target image (step S32: YES), the marking process proceeds to a step S34, in which the marking processing section 13 extracts positions of pixels corresponding to a region which has been marked on the target image. Next, in a step S40, the marking processing section 13 marks, on the color palette 36, colors shown by the pixels which have been extracted. Thereafter, the marking process proceeds to a step S54.

In a case where, in the step S32, the marking processing section 13 determines that the user has carried out marking with respect to the color palette 36 (step S32: NO), the marking process proceeds to a step S44, in which the marking processing section 13 extracts colors shown by pixels which have been marked on the color palette 36. Next, in a step S50, the marking processing section 13 marks, on the target image, the colors that have been extracted. Thereafter, the marking process proceeds to a step S54.

In the step S54, the marking processing section 13 determines whether or not marking has been continued, i.e., the user has carried out marking with respect to the same target image. In a case where the marking processing section 13 determines that marking has been continued (step S54: YES), the marking process proceeds to the step S30. In a case where the marking processing section 13 determines that marking has not been continued (step S54: NO), the marking process with respect to the target image ends.

By the above method, it is possible to bidirectionally reflect marking of regions on a target image and a color palette carried out in response to an input from a user, and possible for the user to efficiently label a region of a target object in the image.

### Software Implementation Example

Each section of the control section 10 may be realized by a logic circuit (hardware) formed on an integrated circuit (IC chip) or the like, or may be alternatively realized by software.

In the latter case, as illustrated in FIG. 14, the control section 10 includes a computer C which executes instructions of a program P that is software realizing the functions of the control section 10. The computer C includes, for example, at least one processor (control device) C1 and at least one computer-readable recording medium M in which the program P is stored. In the computer C, the example object of the present invention is attained by the processor C1 reading the program P from the recording medium M, storing the program P in a memory C2, and executing the program P. The processor C1 can be, for example, a CPU. The recording medium M can be a “non-transitory tangible medium”, for example, a ROM, a tape, a disk, a card, a semiconductor memory, a programmable logic circuit, or the like. Furthermore, the computer C may further include an RAM in which the program P is loaded. The program P can also be supplied to the computer C via any transmission medium (communication network, broadcast wave, or the like) which can transmit the program P. Note that an example aspect of the present invention can also be achieved in the form of a computer data signal in which the program P is embodied via electronic transmission and which is embedded in a carrier wave.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as follows. Note, however, that the present invention is not limited to the following example aspects.

A labeling device according to a first aspect includes: a display processing section which causes a first target image and a color palette to be displayed; and a marking processing section which marks a region on the first target image or a region on the color palette in response to an input from a user, in response to the input from the user with respect to one of the region on the first target image and the region on the color palette, the marking processing section marking the other.

According to the above configuration, it is possible to reflect, to the other, marking of one of the regions on the target image and the color palette carried out in response to the input from the user. This makes it possible for the user to efficiently label a region of a target object in the image.

The labeling device according to a second aspect employs, in addition to the configuration according the first aspect, a configuration in which the marking processing section marks a region which is on at least one second target image and which corresponds to colors included in the region that is on the color palette and that the marking processing section has previously marked.

According to the above configuration, it is possible to carry out marking with respect to the second target image with use of previously accumulated marking colors. Therefore, as more marking colors are accumulated, generalization performance increases, and accordingly it is possible to realize an improvement in accuracy of marking, a reduction in time required for a labeling operation, and a reduction in time required for correction of marking colors.

The labeling device according to a third aspect employs, in addition to the configuration according to the second aspect, a configuration in which the labeling device further includes a marking record storage section in which the colors included in the region that is on the color palette and that the marking processing section has previously marked are accumulated and stored.

According to the above configuration, it is possible to store data concerning previously accumulated marking colors, and therefore possible to easily carry out marking with respect to the second target image.

The labeling device according to a fourth aspect employs, in addition to the configuration according to the third aspect, a configuration in which the marking processing section assigns weights to the respective colors stored in the marking record storage section, and, on the basis of the weights, marks the region on the at least one second target image.

According to the above configuration, it is possible to carry out marking with respect to the second target image on the basis of a result of weighting. Therefore, it is possible to improve the accuracy of marking.

The labeling device according to a fifth aspect employs, in addition to the configuration according the fourth aspect, a configuration in which the weights are assigned to the respective colors stored in the marking record storage section, on the basis of the numbers of times the respective colors have been marked.

According to the above configuration, it is possible to carry out marking with respect to the second target image, on the basis of the numbers of times the respective colors stored in the marking record storage section have been marked. Therefore, it is possible to improve the accuracy of marking.

The labeling device according to a sixth aspect employs, in addition to the configuration according to any one of the third through fifth aspects, a configuration in which the colors included in the region that is on the color palette and that the marking processing section has previously marked are stored in association with identification information in the marking record storage section; and the marking processing section marks the region which is on the at least one second target image and which corresponds to the colors stored in association with specific identification information in the marking record storage section.

According to the above configuration, it is possible to store previously accumulated marking colors in association with any identification information, and carry out marking with respect to the second target image with use of marking colors stored in association with specific identification information, among the previously accumulated marking colors. Thus, it is possible to apply appropriate marking colors.

The labeling device according to a seventh aspect employs, in addition to the configuration according to any one of the third through sixth aspects, a configuration in which the at least one second target image includes a plurality of second target images; and the marking processing section marks a region which is on each of the plurality of second target images and which corresponds to the colors stored in the marking record storage section.

According to the above configuration, it is possible to efficiently carry out marking.

The labeling device according to an eighth aspect employs, in addition to the configuration according to any one of the first through seventh aspects, a configuration in which the marking processing section deletes the region that is on the color palette and that the marking processing section has marked, in response to an input from the user.

According to the above configuration, for example, it is possible to correct erroneous marking, and also remove a noise in a region.

The labeling device according to a ninth aspect employs, in addition to the configuration according to any one of the first through aspects, a configuration in which in response to an input from the user, the marking processing section restricts at least one of the following (i) and (ii): (i) the marking processing section marks the region which is on the color palette and which corresponds to colors included in the region that is on the target image and that the marking processing section has marked in response to the input from the user; and (ii) the marking processing section marks the region which is on the target image and which corresponds to colors included in the region that is on the color palette and that the marking processing section has marked in response to the input from the user.

According to the above configuration, by changing setting in accordance with user's intention, it is possible to efficiently carry out a marking operation.

The labeling device according to a tenth aspect employs, in addition to the configuration according to any one of the first through ninth aspects, a configuration in which the labeling device further includes a target range specifying section which specifies a target range in the target image, the marking processing section marking the region in the target range.

According to the above configuration, it is possible to narrow down a range of a region to be marked. Therefore, it is possible to improve the efficiency of user's marking operation.

The labeling device according to an eleventh aspect employs, in addition to the configuration according to the tenth aspect, a configuration in which the color palette is made up of colors included in the target range which the target range specifying section has specified.

According to the above configuration, it is possible to reduce the types of colors to be displayed on the color palette. Therefore, it is possible to select, in detail, the range of colors to be marked.

The labeling device according to a twelfth aspect employs, in addition to the configuration according to the tenth or eleventh aspect, a configuration in which the target range specifying section specifies the target range in accordance with a result of detection of a specific object from the target image.

According to the above configuration, it is possible to appropriately and efficiently specify a target range.

A labeling method according to a thirteenth aspect includes: causing a first target image to be displayed; causing a color palette to be displayed; marking a region on the first target image or a region on the color palette in response to an input from a user; and in response to the input from the user with respect to one of the region on the first target image and the region on the color palette, marking the other.

According to the above configuration, it is possible to reflect, to the other, marking of one of the regions on the target image and the color palette carried out in response to the input from the user. This makes it possible for the user to efficiently label a region of a target object in the image.

A labeling program according to a fourteenth aspect causes a computer to carry out: a process of causing a first target image to be displayed; a process of causing a color palette to be displayed; a process of marking a region on the first target image or a region on the color palette in response to an input from a user; and a process of, in response to the input from the user with respect to one of the region on the first target image and the region on the color palette, marking the other.

According to the above configuration, it is possible to bidirectionally reflect marking of the regions on the target image and the color palette carried out in response to the input from the user. It is possible to reflect, to the other, marking of one of the regions on the target image and the color palette carried out in response to the input from the user. The present invention also encompasses a computer-readable non-transitory recording medium in which the above labeling program is stored.

### REFERENCE SIGNS LIST

10 . . . Control section
11 . . . Display processing section
12 . . . Image preprocessing section
13 . . . Marking processing section
14 . . . Marking recording section
15 . . . image obtaining section
16 . . . Target range specifying section
21 . . . Image storage section
22 . . . Marking record storage section
30 . . . device
31 . . . First display part (first display region)
321, 322, 32i . . . Target image
35 . . . display part (second display region)
36, 38, 39 . . . Color palette
37 . . . Auxiliary bar
42 . . . Target range
41 . . . Input device
501, 502, 503, 504 . . . Marked region on target image
601, 603, 604, 60X . . . Marked region on color palette
100, 200 . . . Labeling device

What is claimed is:

1. A labeling device comprising at least one processor,
the at least one processor carrying out:
a display process of causing a first target image and a color palette to be displayed; and
a marking process of marking a region on the first target image and a region on the color palette in response to an input from a user,
in the marking process, in response to the input from the user with respect to one of the region on the first target image and the region on the color palette, the at least one processor marking the other.

2. The labeling device as set forth in claim 1, wherein, in the marking process, the at least one processor marks a region which is on at least one second target image and which corresponds to colors included in the region that is on the color palette and that the at least one processor has previously marked in the marking process.

3. The labeling device as set forth in claim 2, wherein the at least one processor further carries out
a marking record storing process of accumulating and storing the colors included in the region that is on the color palette and that the at least one processor has previously marked in the marking process.

4. The labeling device as set forth in claim 3, wherein, in the marking process, the at least one processor assigns weights to the respective colors stored, and, on the basis of the weights, marks the region on the at least one second target image.

5. The labeling device as set forth in claim 4, wherein, in the marking process, the at least one processor assigns the weights to the respective colors stored, on the basis of the numbers of times the respective colors have been marked.

6. The labeling device as set forth in claim 3, wherein:
in the marking record storing process, the at least one processor stores the colors included in the region that is on the color palette and that the at least one processor has previously marked, in association with identification information; and
in the marking process, the at least one processor marks the region which is on the at least one second target image and which corresponds to the colors stored in association with specific identification information.

7. The labeling device as set forth in claim 3, wherein:
the at least one second target image includes a plurality of second target images; and
in the marking process, the at least one processor marks a region which is on each of the plurality of second target images and which corresponds to the colors stored.

8. The labeling device as set forth in claim 1, wherein, in the marking process, the at least one processor deletes the region that is on the color palette and that the at least one processor has marked, in response to an input from the user.

9. The labeling device as set forth in claim 1, wherein:
in the marking process, in response to an input from the user, the at least one processor restricts at least one of the following (i) and (ii):
(i) the at least one processor marks the region which is on the color palette and which corresponds to colors included in the region that is on the first target image and that the at least one processor section has marked in response to the input from the user; and
(ii) the at least one processor marks the region which is on the first target image and which corresponds to colors included in the region that is on the color palette and that the at least one processor has marked in response to the input from the user.

10. The labeling device as set forth in claim 1, wherein:
the at least one processor further carries out a target range specifying process of specifying a target range in the first target image; and
in the marking process, the at least one processor marks the region in the target range.

11. The labeling device as set forth in claim 10, wherein the color palette is made up of colors included in the target range which has been specified.

12. The labeling device as set forth in claim 10, wherein, in the target range specifying process, the at least one processor specifies the target range in accordance with a result of detection of a specific object from the first target image.

13. A labeling method, comprising:
(a) causing a first target image to be displayed;
(b) causing a color palette to be displayed;
(c) marking a region on the first target image or a region on the color palette in response to an input from a user; and
(d) in response to the input from the user with respect to one of the region on the first target image and the region on the color palette, marking the other,
the steps (a) through (d) being carried out by at least one processor.

14. (canceled)

15. A computer-readable non-transitory recording medium in which a labeling program for causing a computer to function as a labeling device is stored,
the labeling program causing the computer to carry out:
a process of causing a first target image to be displayed;
a process of causing a color palette to be displayed;
a process of marking a region on the first target image or a region on the color palette in response to an input from a user; and
a process of, in response to the input from the user with respect to one of the region on the first target image and the region on the color palette, marking the other.
